(19) United States
(12) Patent Application Publication
(10) Pub. No.: US 2009/0280952 A1
(43) Pub. Date: Nov. 12, 2009

(54) Method for operating a continuously variable conical pulley transmission

(75) Inventors: Marco GRETHEL, Buhlertal (DE); Eric MÜLLER, Kaiserslautern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/387,236

(22) Filed: Apr. 29, 2009

Related U.S. Application Data
(60) Provisional application No. 61/125,929, filed on Apr. 30, 2008.

(51) Int. Cl. F16H 61/662

(52) U.S. Cl. 477/46

(57) ABSTRACT

A method for operating a continuously variable conical pulley transmission having two conical pulley sets that are operatively coupled by a endless torque-transmitting means, so that the transmission ratio between the conical pulley sets is continuously variable. A hydraulic medium is supplied to the continuously variable conical pulley transmission in a stop phase of a start/stop operation by means of a pump unit that includes a pump that is driven by an electric motor. The electric motor is controlled as a function of the temperature of the hydraulic medium.

### BACKGROUND OF THE INVENTION

1. Field of the Invention

The present invention relates to a method for operating a continuously variable conical pulley transmission having two sets of conical pulleys that are operatively coupled with one another by an endless torque-transmitting means, so that the transmission ratio between the two conical pulley sets is continuously variable. A hydraulic medium is provided to the continuously variable conical pulley transmission in the stop phase of a start/stop operation by means of a pump unit that includes an electrically operated pump that is driven by an electric motor.

2. Description of the Related Art

In order to improve gas mileage, motor vehicles are increasingly equipped with a so-called start/stop strategy. In vehicles having a continuously variable conical pulley transmission, an example of which is disclosed in U.S. Pat. No. 7,264,564, the entire contents of which are hereby incorporated by reference, electrically driven boost pumps can be used, which support the transmission hydraulics when accelerating from a stop. That assures very fast driveability from the so-called stop phase. The electrically driven boost pump preferably operates until a main pump can reliably take over the hydraulic supply. The main pump is preferably mechanically driven by an internal combustion engine, e.g. through a drive shaft. The boost pump is preferably driven by an electric motor so that it can cover all borderline situations.

It is an object of the present invention to reduce mechanical and/or hydraulic losses occurring during the operation of a continuously variable conical pulley transmission.

### SUMMARY OF THE INVENTION

The object of the invention is achieved by a method for operating a continuously variable conical pulley transmission having two conical pulley sets that are operatively coupled with one another by an endless torque-transmitting means, so that the transmission ratio between the conical pulley sets is continuously variable. A hydraulic medium is supplied to the continuously variable conical pulley transmission in a stop phase of a start/stop operation by means of an electrically operated pump unit that is driven by an electric motor, by controlling the electric motor as a function of the temperature of the hydraulic medium. In that way, the power consumption of the electrically operated pump unit can be adapted in a simple manner to the changing power requirement of the continuously variable conical pulley transmission.

Preferred embodiments of the method are characterized in that the temperature of the hydraulic medium is detected at the beginning of the stop phase, and/or monitored during the stop phase. Conventional sensors are preferably used for detecting or monitoring the temperature of the hydraulic medium.

Another preferred embodiment of the method is characterized in that a required target speed of the electric motor is determined as a function of the temperature of the hydraulic medium when restarting after the stop phase. The required target speed of the electric motor is determined, e.g., by a characteristic diagram as a function of the temperature of the hydraulic medium.

Another preferred embodiment of the method is characterized in that the speed and/or the power of the electric motor is controlled as a function of the temperature of the hydraulic medium, so that temperature effects that result from the different temperatures of the hydraulic medium are compensated for. Thus, operation of the electric motor at constant power or at constant speed is facilitated at different temperatures of the hydraulic medium.

Other advantages, features, and details of the invention become evident from the subsequent description, which describes various embodiments in detail.

### DESCRIPTION OF THE PREFERRED EMBODIMENTS

In the context of the present invention, it was found that the electrically operated pump unit is operated at borderline power in conventional start/stop strategies, when accelerating from a stop, regardless of the actual hydraulic medium requirement. In that away the electrical system of the motor vehicle is highly loaded when accelerating from a stop. Among other things, it was tested in the context of the present invention whether it is always necessary to provide the maximum possible boost supply. Thus, it was found that it is unnecessary in many cases to operate the electric pump unit at borderline power.

Hydraulic systems for supplying continuously variable conical pulley transmissions with a hydraulic medium have to be configured for operation with extremely hot hydraulic medium, in particular transmission oil. In that context, three issues are relevant. First, the transmission components empty to a higher degree and quicker when the transmission oil is hot. Second, the leakage is substantial when the transmission components are filled again. Third, the so-called volumetric efficiency of the electric pump unit is small. Therefore, the electric pump unit either has to be very large or the electric motor used for driving the electric pump unit has to rotate very fast to comply with such requirements.

The requirements placed upon the electric pump unit decrease when the oil temperature decreases. First, the transmission components do not run empty to such high extent or that quickly when the oil temperature decreases. Second, the filling losses decrease. Third, the volumetric efficiency of the electric pump unit increases. On the other hand, the so-called mechanical/hydraulic efficiency of the electric pump unit with reference to the same speed decreases. Therefore, the electric pump unit can run at lower speed when the oil is colder. Due to the slower speed, the mechanical/hydraulic losses are reduced further.

According to an important aspect of the present invention, the electric motor that is used for driving the electric pump unit is reduced with respect to its speed or power, depending upon the temperature of the hydraulic medium, in particular the temperature of the transmission oil. Thus, using brushless electric motors has proven advantageous.

According to a first embodiment of the present invention, the oil temperature is detected when the internal combustion engine is turned off, or the oil temperature is monitored during the standstill phase. Depending upon the oil temperature, the target speed of the electric motor required at a restart is determined, e.g., by a characteristic diagram.

According to a second embodiment of the present invention, the hydraulic system is configured, so that the temperature effects described previously compensate one another. The effects compensating each other with respect to the oil requirement are used in order to maintain the power required by the electric pump unit substantially constant.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for operating a continuously variable conical pulley transmission having two conical pulley sets that are operatively coupled by an endless torque-transmitting means, so that the transmission ratio between the conical pulley sets is continuously variable, said method comprising the steps of: supplying hydraulic medium to the continuously variable conical pulley transmission in a stop phase of a start/stop operation by means of a pump unit that includes an electric pump that is driven by an electric motor, and controlling the electric motor output as a function of the temperature of the hydraulic medium.

2. A method according to claim 1, including the step of detecting the temperature of the hydraulic medium at the beginning of the stop phase.

3. A method according to claim 1, including the step of monitoring the temperature of the hydraulic medium during the stop phase.

4. A method according to claim 1, including the step of determining a target speed of the electric motor required for a restart after the stop phase as a function of the temperature of the hydraulic medium.

5. A method according to claim 1, including the step of controlling one of the speed and the power of the electric motor as a function of the temperature of the hydraulic medium, so that temperature effects that result from different temperatures of the hydraulic medium are compensated for.
